(19) United States
(12) Patent Application Publication
(10) Pub. No.: US 2023/0027905 A1
(43) Pub. Date: Jan. 26, 2023

(54) MASSAGE DEVICE, CONTROL SYSTEM AND CONTROL METHOD FOR CONTROLLING MASSAGE DEVICE

(71) Applicant: SHENZHEN SVAKOM TECHNOLOGY CO., LTD, SHENZHEN (CN)

(72) Inventors: YONG YU, SHENZHEN (CN); MINCHAO HE, SHENZHEN (CN); YONGQING WANG, SHENZHEN (CN); GUOHUI ZHANG, SHENZHEN (CN)

(21) Appl. No.: 17/853,951

(22) Filed: Jun. 30, 2022

Related U.S. Application Data
(63) Continuation-in-part of application No. 17/676,201, filed on Feb. 20, 2022, now Pat. No. 11,452,665.
Application No. 17/676,201 is a continuation-in-part of application No. 17/382,363, filed on Jul. 22, 2021.

(51) Int. Cl. A61H 9/00; G05B 15/02

(52) U.S. Cl. CPC A61H 9/0057; G05B 15/02; A61H 2201/5097; A61H 2201/1246; A61H 2201/501; A61H 2201/5046

(57) ABSTRACT

The massage device includes a housing; a massage unit arranged at the housing, wherein the massage unit comprises a piston, arranged inside the chamber body; and a driving device, configured to drive the piston to reciprocate inside the chamber body so as to generate negative pressure at the suction nozzle; a massage control unit, configured to control the massage unit to work; and a wireless communication unit, arranged on the housing and configured to communicate with a terminal device so as to allow the terminal device to control the massage control unit to have the massage unit to work wirelessly.

### CROSS-REFERENCE TO RELATED APPLICATIONS

This application is a continuation-in-part of U.S. application Ser. No. 17/382,363, filed on Jul. 22, 2021, and U.S. application Ser. No. 17/676,201, filed on Feb. 20, 2022, the contents of which are incorporated by reference herein.

### FIELD

The subject matter herein generally relates to massage devices, control systems and control methods for controlling a massage device, and particularly relates to a massage device with a wireless communication unit, a control system and a control method for controlling a massage device wirelessly.

### BACKGROUND

With acceleration of the pace of life, the pressure on people's work increases. After a day's work, the human body is very tired and aching. In order to relieve fatigue and soreness, people usually use a variety of massaging devices to massage the chamber body, such as negative pressure massaging devices.

### SUMMARY

An embodiment of the present disclosure provides a massage device, which includes: a housing; a massage unit arranged at the housing, wherein the massage unit includes a piston, arranged inside the chamber body; and a driving device, configured to drive the piston to reciprocate inside the chamber body so as to generate negative pressure at the suction nozzle; a massage control unit, configured to control the massage unit to work; and a wireless communication unit, arranged on the housing and configured to communicate with a terminal device so as to allow the terminal device to control the massage control unit to have the massage unit to work wirelessly.

In at least one embodiment, the wireless communication unit is configured to receive control commands from the terminal device, the massage control unit is configured to control the massage unit to work according to the control commands.

In at least one embodiment, the wireless communication unit includes a Bluetooth® module, the control commands are transmitted through the Bluetooth® module.

In at least one embodiment, the massage control unit includes a processor and a storage device, the storage device stores a first APP and a second APP, the first APP is configured to be executed by the processor to provide an interactive user interface and generate the control commands; the second APP is configured to allow the terminal device to remote-control the massage device.

In at least one embodiment, the control parameters include at least one of massage mode, massage speed, massage frequency, massage strength, and massage time.

In at least one embodiment, the interactive user interface includes virtual buttons which is capable of being activated to set the control parameters or a virtual drawing panel which allows a user to draw a curve within an axis on the virtual drawing panel to serve as the control parameters.

An embodiment of the present disclosure provides a control system. The terminal device includes: a massage device; and a first terminal device in a wireless communication with the massage device. The first terminal device is configured to: enable a first APP; provide an interactive user interface; receive control parameters from the interactive user interface; generate control commands based on the control parameters; and transmit the control commands to the massage device to control the massage device to work.

In at least one embodiment, the interactive user interface includes virtual buttons which is capable of being activated to set the control parameters or a virtual drawing panel which allows a user to draw a curve within an axis on the virtual drawing panel to serve as the control parameters.

In at least one embodiment, the control parameters comprise at least one of massage mode, massage speed, massage frequency, massage strength, and massage time.

In at least one embodiment, the control system further includes a second terminal device, wherein the second terminal device is configured to remote-control the first terminal device to enable the first APP.

In at least one embodiment, the control system further includes a server configured to provide a website, wherein the website is configured to allow the first terminal device to define tip parameters and the second terminal device to input tips, to receive tips from the second terminal device, to determine whether received tips fall within the tip parameters, and to signal the first terminal device whether received tips fall within the tip parameters. The first terminal device is further configured to: access the web site through a web browser to input tip parameters; receive signals from the web site indicating whether received tips fall within the tip parameters; and transmit a remote-control request to the second terminal device to allow the second terminal device to remote-control the first terminal device. The second terminal device is further configured to: access the website through a web browser to input tips; and remote-control the first terminal device in response to the remote-control request.

In at least one embodiment, the first terminal device includes a first video device configured to provide live stream of the massage device to the web site during work time of the massage device, and the second terminal device includes a second video device configured to receive live stream of the massage device from the website.

In at least one embodiment, the tip parameters comprise at least one tip value range, each tip value range corresponds to a work time of the massage device.

In at least one embodiment, the control system further includes a second terminal device and a server configured to provide a website. The website is configured to allow a first terminal device to define tip parameters and a second terminal device to input tips, to receive tips from the second terminal device, to determine whether received tips fall within the tip parameters, and to signal the first terminal device whether received tips fall within the tip parameters. The first terminal device is configured to: access the web site through a web browser to input tip parameters; receive signals from the web site indicating whether received tips fall within the tip parameters; and enable the first APP if received tips fall within the tip parameters. The second terminal device is configured to: access the website through a web browser to input tips.

In at least one embodiment, the first terminal device is further configured to: transmit the interactive user interface to the web site; and receive control parameters from the website. The second terminal device is further configured to: input control parameters on the interactive user interface through the website.

In at least one embodiment, the control commands are transmitted to the massage device over Bluetooth®.

An embodiment of the present disclosure provides a non-transitory storage medium having instructions stored thereon, wherein the instructions includes a first APP that, when executed by a processor, causes the processor to: provide an interactive user interface; receive control parameters from the interactive user interface; and generate control commands based on the control parameters, wherein the control commands are configured to control a massage device to work according to the control commands, and the non-transitory storage medium is configured to be arranged on a first terminal device or the massage device.

In at least one embodiment, the interactive user interface includes virtual buttons which is capable of being activated to set the control parameters or a virtual drawing panel which allows a user to draw a curve within an axis on the virtual drawing panel to serve as the control parameters.

In at least one embodiment, control parameters include at least one of massage mode, massage speed, massage frequency, massage strength, and massage time.

In at least one embodiment, the instructions when executed by the processor, further causes the processor to: receive remote-control from a second terminal device; and enable the first APP according to the remote-control.

The massage device provided by the present disclosure, allow a user to control operation of the massage device in a wireless manner, which is convenient and improve user experience.

### BRIEF DESCRIPTION OF THE DRAWINGS

Implementations of the present disclosure will now be described, by way of embodiment, with reference to the attached figures. It should be understood, the drawings are shown for illustrative purpose only, for ordinary person skilled in the art, other drawings obtained from these drawings without paying creative labor by an ordinary person skilled in the art should be within scope of the present disclosure.

FIG. 1 is a schematic view of a massage device according to an embodiment of the present disclosure.

FIG. 2 is a schematic view illustrating a control system according to a first embodiment of the present disclosure.

FIG. 3(a) is an exemplary interactive user interface.

FIG. 3(b) is another exemplary interactive user interface.

FIG. 4 is a schematic view illustrating a control system according to a second embodiment of the present disclosure.

FIG. 5 is a schematic view illustrating a control system according to a third embodiment of the present disclosure.

FIG. 6 is a schematic view illustrating a control system according to a fourth embodiment of the present disclosure.

FIG. 7 is a schematic view illustrating a control system according to a fifth embodiment of the present disclosure.

FIG. 8 is a flow chart of a control method for controlling a massage device according to a first embodiment of the present disclosure.

FIG. 9 is a flow chart of a control method for controlling a massage device according to a second embodiment of the present disclosure.

FIG. 10 is a flow chart of a control method for controlling a massage device according to a third embodiment of the present disclosure.

FIG. 11 is flow chart of a control method for controlling a massage device according to a fourth embodiment of the present disclosure.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the exemplary embodiments described herein. However, it will be understood by those of ordinary skill in the art that the exemplary embodiments described herein may be practiced without these specific details. In other instances, methods, procedures, and components have not been described in detail so as not to obscure the related relevant feature being described. Also, the description is not to be considered as limiting the scope of the exemplary embodiments described herein. The drawings are not necessarily to scale and the proportions of certain parts may be exaggerated to better illustrate details and features of the present disclosure.

The term “comprising” when utilized, means “including, but not necessarily limited to”; it specifically indicates open-ended inclusion or membership in the so-described combination, group, series, and the like. The disclosure is illustrated by way of example and not by way of limitation in the figures of the accompanying drawings in which like references indicate similar elements. It should be noted that references to “an” or “one” embodiment in this disclosure are not necessarily to the same embodiment, and such references can mean “at least one”. In addition, the terms “first” and “second” are used for descriptive purposes only and cannot be understood as indicating or implying relative importance or implying the number of indicated technical features. Thus, the features defined as “first” and “second” may explicitly or implicitly include one or more of the said features. In the description of embodiments of the invention, “a plurality of” means two or more, unless otherwise specifically defined.

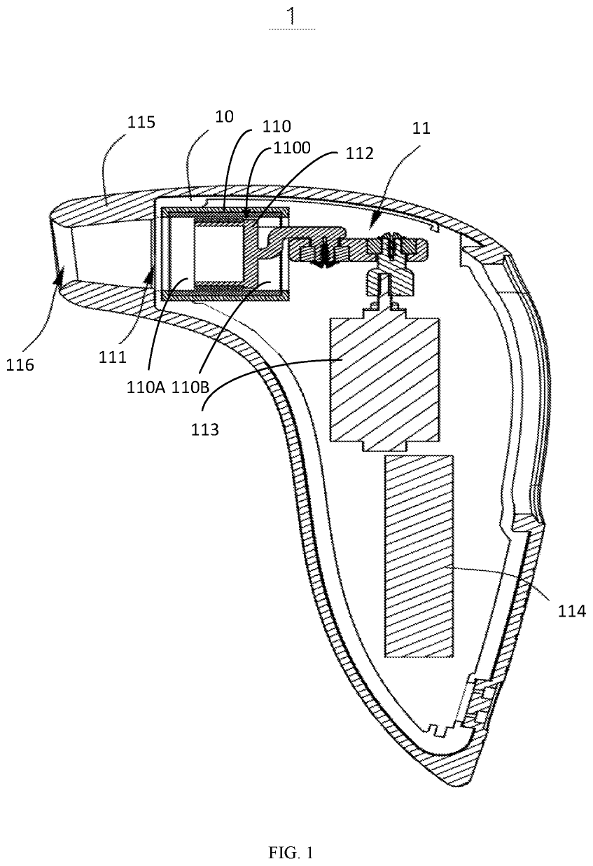

Referring to FIG. 1, an embodiment of the present disclosure provides a massage device 1 including a housing 10 and a massage unit 11 arranged at the housing 10. The massage unit 11 includes a chamber body 110 with a suction nozzle 111, a piston 112 arranged inside the chamber body 111, a driving device 113 configured to drive the piston 112 to reciprocate so as to generate negative pressure at the suction nozzle 111, and a power unit 114 configured to provide power to the massage unit 11. The piston 112 separates the chamber body 110 into a first chamber 110A and a second chamber 110B. The first chamber 110A communicates with the suction nozzle 111. When in use, the suction nozzle 111 is attached to human body, and the driving device 113 drives the piston 112 to move away from the suction nozzle 111 so that a volume of the first chamber 110A is increased and negative pressure is generated at the suction nozzle 111. Therefore, the suction nozzle 111 can be sucked firmly onto the human body under the negative pressure. In a further embodiment, the massage device 1 further includes a silicon cover 115 surrounding the housing 10. The silicon cover 115 defines an opening 116 communicating with the suction nozzle 111. When the driving device 113 drives the piston 112 to move away from the suction nozzle 111, negative pressure is generated at the opening 116 so make the human body is sucked to the opening 116 of the massage device 1. The silicon cover 115 can improve comfort.

In at least one embodiment, A gap 1100 is defined between the piston 112 and an inner wall of the chamber body 110. Only when the gap 1100 is not greater than 0.1 mm, a dynamic pressure may be generated at the opening 116 and the suction nozzle 111, i.e., the negative pressure may be generated at the opening 116 and the suction nozzle 111. By defining the gap 1100 to be smaller, a larger noise may be prevented while using the massage device 1, achieving a noise reduction. In use, the drive device may be arranged to allow the piston 112 to move along a length direction in the chamber body 110 reciprocally. When the suction nozzle 111 of the massager device 1 is attached to the skin, the opening 116 and the suction nozzle 111 is covered. The piston 112 moving reciprocally may change a volume of the receiving space defined by the chamber body 110. In this way, an internal air pressure is dynamically changed, even when the receiving space defined by the chamber body 110 generates the alternating positive and negative pressures. Preferably, the gap 1100 is not greater than 0.05 mm.

The massage device further includes a massage control unit and a wireless communication unit. Through the wireless communication unit, the massage device can receive control commands wirelessly and the massage control unit controls the massage unit to work according to the control commands, thus achieving wireless control of the massage device 1. In the embodiment, the massage control unit controls the massage unit to work means the massage control unit controls the piston move away/towards the suction nozzle so as to suck user's skin at the suction nozzle.

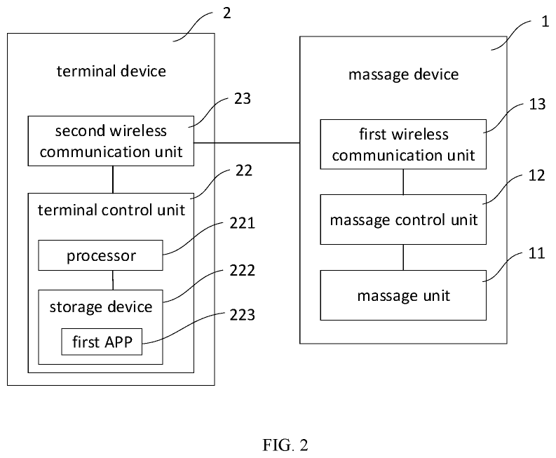

Referring to FIG. 2, a control system according to a first embodiment of the present disclosure includes a massage device 1 and a terminal device 2. The massage device 1 further includes a massage control unit 12 and a first wireless communication unit 13 arranged inside the housing 10. The first wireless communication unit 13 is configured to communicate with a terminal device 2 wirelessly. The first wireless communication unit 13 can include at least one of a Bluetooth® module, a Wi-Fi module, or a mobile communication module such as 2G, 3G, 4G or 5G. Through the first wireless communication unit 13, the massage device 1 can receive control commands from a terminal device 2. The massage control unit 12 configured to control the massage unit 11 according to the control commands. Therefore, the terminal device 2 can control operation of the massage device 1 wirelessly, which can greatly improve convenience.

The terminal device 2 may be a notebook, a tablet PC, or a mobile phone. The terminal device 2 includes a second wireless communication unit 23 corresponding to the first wireless communication unit 13 and a terminal control unit 22. The terminal control unit 22 is configured to generate control commands and transmit the control commands through the second wireless communication unit 23 and the first wireless communication unit 13 to the massage control unit 12 so as to control operation of the massage unit 11. The terminal control unit 22 may include a processor 221 and a storage device 222. The storage device 222 is configured to store instructions or APP, which can be executed by the processor to generate the control commands. In the embodiment, the storage device 222 stores a first APP 223. The first APP 223 is configured to be executed by the processor 221 to provide an interactive user interface. The interactive user interface is configured to allow a user to set control parameters of the massage device 1. In at least one embodiment, the control parameters may include at least one of massage mode, massage time, massage strength, massage frequency, massage speed, and etc. In the embodiment, the massage strength may be determined by travel of the piston (a distance that the piston moves away from the suction nozzle). The greater the travel, the greater the massage strength.

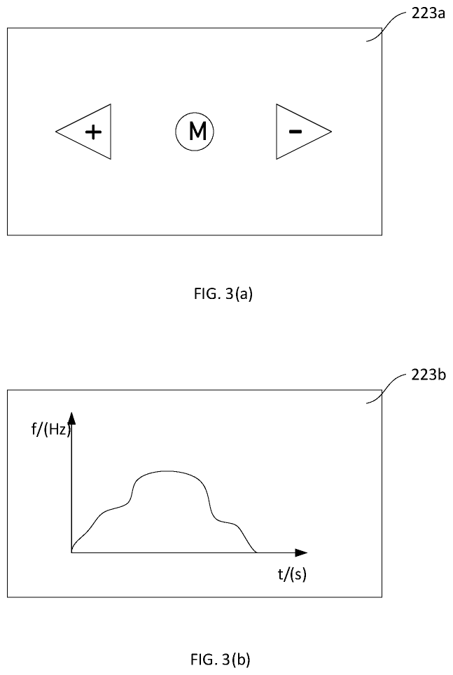

Referring to FIGS. 3(a) and 3(b), two exemplary interactive user interface 223a and 223b is illustrated. In the interactive user interface 223a, there are three virtual buttons. When the left virtual button is activated, massage speed is increased, when the right virtual button is activated, massage speed is decreased, and when the middle virtual button is activated, a working mode is changed. The working mode may be sucking, pinching or hitting, and etc.

The interactive user interface 223b provides a virtual drawing panel which allows a user to draw a curve within an axis on screen as control parameters. For example, X-axis of the axis represent time t(s), Y-axis of the axis represents frequency f(HZ). It should be understood that, X-axis and Y-axis can represent other control parameters, for example, Y-axis can represent speed while X-axis represent time t(s). In at least one embodiment, the interactive user interface 223b is configured to allow a user to choose control parameters and set values according to user's preference. The first APP 223 is configured to generate control commands based on the control parameters set by the user.

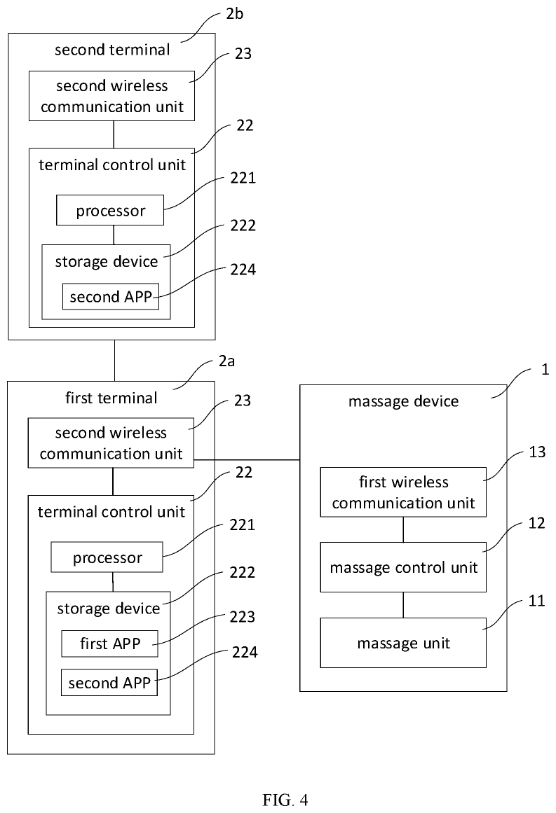

Referring to FIG. 4, a schematic view showing a control system according to a second embodiment is illustrated. In the second embodiment, the control system includes a first terminal device 2a, a second terminal device 2b and the massage device 1 communicated with the first terminal device 2a. The second terminal device 2b controls the operation of the massage device 1 through the first terminal device 2a. The first terminal device 2a is similar with the terminal device 2 in the first embodiment, and a difference between the first terminal device 2a and the terminal device 2 is, the storage device 222 of the first terminal device 2a stores the first APP 223 and a second APP 224. The first APP 223 of the second embodiment is same with the first APP 223 of the first embodiment. The second APP 224 is configured to interact with the second terminal device 2b. The second terminal device 2b is similar with the first terminal device 2 and a difference between the second terminal device 2b and the terminal device 2 is the storage device 222 of the second terminal device 2b stores the second APP 224. The second APP 224 is configured to allow the second terminal device 2b controls operation of the first terminal device 2a, for example, access or edit data stored in the first terminal device 2a, enable/disable APPs stored in the first terminal device. The second APP 224 may be any existing remote desktop software. The first terminal device may have a control code, the second terminal device can remote-controls the first terminal based on the control code. The first terminal device 2a and the second terminal device 2b can communicate through mobile communication module (e.g. 2G/3G/4G/5G). The first terminal device 2a and the massage device 1 can communicate with a Bluetooth® module. The second terminal device 2b remote-controls the first terminal device 2a to enable the first APP 223 to provide the interactive user interface. The user of the second terminal device 2b can set control parameters through the interactive user interface and the first APP 223 generates control commands according to the control parameters set by the user of the second terminal device 2b and the control commands is transmitted to the massage device through the second wireless communication unit 23 and the first wireless communication unit 13 to control the massage device to work.

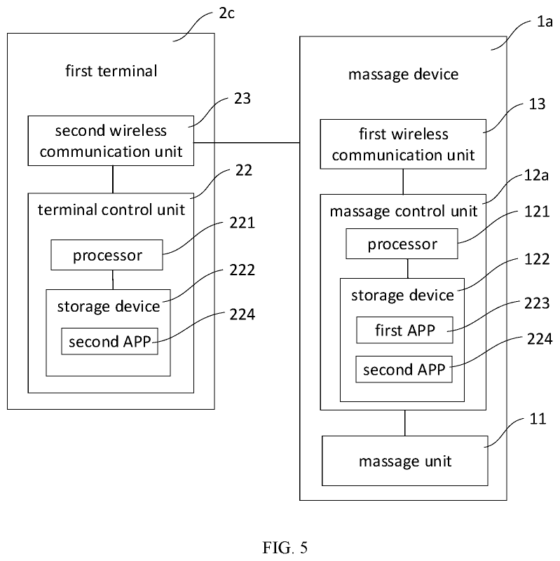

Referring to FIG. 5, a schematic view showing a control system according to a third embodiment is illustrated. In the third embodiment, the control system includes a first terminal device 2c and a massage device 1a. The first terminal device 2c communicate a massage device 1a and controls the massage device 1a to work remotely. The first terminal device 2c is same with the second terminal device 2b of the second embodiment. The storage device 222 of the first terminal device 2c stores the second APP 224. The massage device 1a is similar with the massage device 1 and a difference between the massage device 1a and the massage device 1 is the massage control unit 12a is different from the massage control unit 12. The massage control unit 12a includes a processor 121, a storage device 122. The storage device 122 stores the first APP 223 and the second APP 224. The first APP 223 can be executed by the processor 121 to provide the interactive use interface. The second APP 224 is configured to allow the user of the first terminal device 2c to remote controls the massage device 1a, for example, existing remote desktop software. The first terminal device 2c remote controls the massage device through the second APP 224 to enable the first APP 223 to provide the interactive user interface to allow the user of the first terminal device 2c to set control parameters through the interactive user interface. The first APP 223 is configured to generate control commands based on the control parameters and the massage control unit 12a controls the massage unit 11 to work according to the control commands.

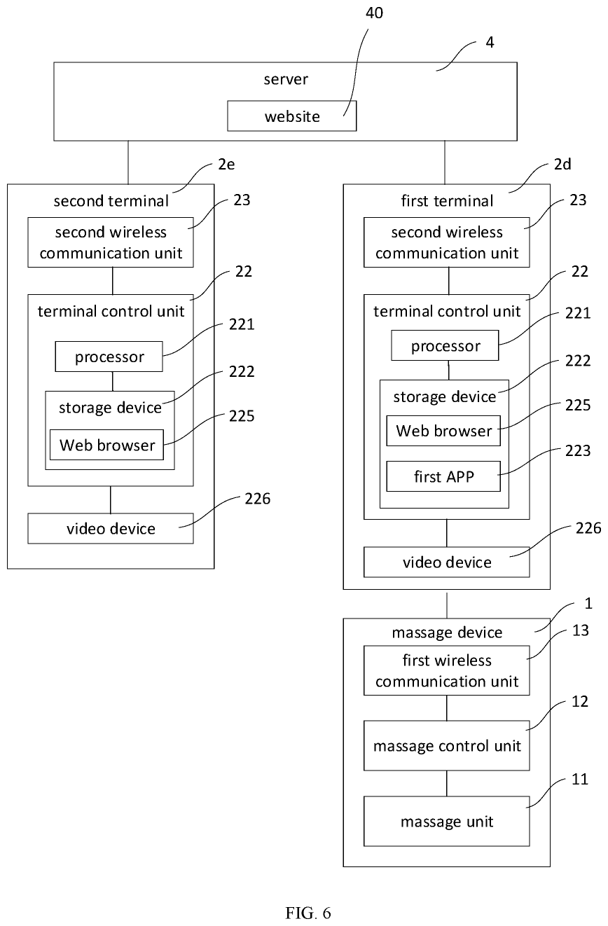

Referring to FIG. 6, a schematic view showing a control system according to a fourth embodiment is illustrated. In the fourth embodiment, the control system includes a massage device 1, a first terminal device 2d, a second terminal device 2e and a server 4. The first terminal device 2d and the second terminal device 2e communicate with the server 4. The first terminal device 2d and the second terminal device 2e is similar with the terminal device 2 of the first embodiment. The difference between the first terminal device 2d and the second terminal device 2e and the terminal device 2 is that the storage device 222 of the terminal device 2d and the second terminal device 2e includes a Web browser 225. The server 4 provides a website 40, the first terminal device 2d and the second terminal device 2e can access the website 40 through the web browser 225 to chat with each other. The website 40 is configured to allow the first terminal device 2d to define tip parameters, receive tips from the second terminal device 2e, and determine whether the received tips fall within the tip parameters defined by the first terminal device 2d. If the received tips fall within the tip parameters defined by the first terminal device 2d, the first terminal device 2d controls the massage device 1 to work.

The server 4 includes a memory unit having instructions stored thereon, and a processor, wherein the processor is configured to execute the instructions resulting in a software such as the web site 40.

The web site 40 is configured to allow a first user of the first terminal device 2d and a second user of the second terminal device 2e to set up a first user account and a second user account, respectively. In this regard, the first user can create the first user account by inputting his or her user's name and password and input payment information, among other types of information associated with the first user. Similarly, the second user can create the second user account by inputting the second user's name, age, gender, location, and the like. The first user account information and the second user account information are stored in a database that is connected to the server 4. It is contemplated that the second user can purchase credits, points, or other types of virtual currency such as tokens that can be credited to the second user's account and use the virtual currency to tip the first user.

In at least one embodiment, if the website 40 determines that the received tip falls within the tip parameters, it signals the first APP 223 stored on the first terminal device 2d to provide the interactive user interface, receive an interactive result from the interactive interface and feeds back the interactive result to the first APP 223. The first APP 223 controls the massage unit 11 to work according to the interactive result. If the website 40 determines that the received tip does not fall into any of the tip parameters, the website 40 may be configured to send a notification to the second user indicating that the tip amount is insufficient.

In at least one embodiment, the first terminal device 2d and the second terminal device 2e may include a video device. The user of the first terminal device 2d may provide live stream of the massage device during work time of the massage device to the web site, and the user of the second terminal device 2e may view the live stream through the website in real time.

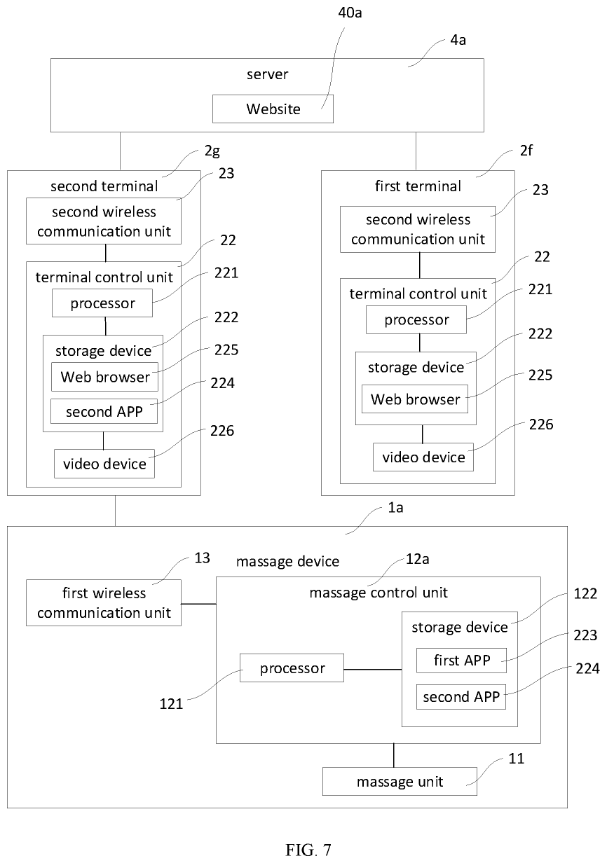

Referring to FIG. 7, a schematic view showing a control system according to a fifth embodiment is illustrated. In the fifth embodiment, the control system includes a massage device 1a, a first terminal device 2f, a second terminal device 2g, and a server 4a. The first terminal device 2f and the second terminal device 2g communicate with the server 4a. The server 4a is similar with the server 4 and includes a memory unit having instructions stored thereon, and a processor, wherein the processor is configured to execute the instructions resulting in a software such as the website 40a. The first terminal device 2f and the second terminal device 2g is similar with the terminal device 2 of the first embodiment. The difference between the first terminal device 2f and the second terminal device 2g and the terminal device 2 is that the storage device 222 of the terminal device 2f and the second terminal device 2g includes a Web browser 225. The second terminal device 2f further includes a second APP 224. The server 4a provides a web site 40a, the first terminal device 2f and the second terminal device 2g can access the web site 40a through the web browser 225 to chat with each other. The website 40a is configured to allow the first terminal device 2f to define tip parameters, receive tips from the second terminal device 2g, and determine whether the received tips fall within the tip parameters defined by the first terminal device 2f. If the received tips fall within the tip parameters defined by the first terminal device 2f, the first terminal device 2f controls the massage device 1 to work.

The web site 40a is configured to allow a first user of the first terminal device 2f and a second user of the second terminal device 2g to create a first user account and a second user account, respectively. In this regard, the first user can create the first user account by inputting his or her user's name and password and input payment information, among other types of information associated with the first user. Similarly, the second user can create the second user account by inputting the second user's name, age, gender, location, and the like. The first user account information and the second user account information are stored in a database that is connected to the server 4a. It is contemplated that the second user can purchase credits, points, or other types of virtual currency such as tokens that can be credited to the second user's account and use the virtual currency to tip the first user.

In at least one embodiment, if the website 40a determines that the received tip falls within the tip parameters, it signals the first terminal device 2f to send a remote-control request to the second terminal device 2g such that the second terminal device 2g can control the massage device 1a. The second terminal device 2g enables the first APP stored on the first terminal device 2f to provide the interactive user interface and set control parameters through the interactive user interface. The first APP 223 generates control commands to control operation of the massage unit 11 according to control parameters. If the web site 40 determines that the received tip does not fall into any of the tip parameters, the website 40a may be configured to send a notification to the second user indicating that the tip amount is insufficient.

In at least one embodiment, the first terminal device 2f and the second terminal device 2g may include a video device. The user of the first terminal device 2f may provide live stream of the massage device during work time of the massage device to the web site, and the user of the second terminal device 2g may view the live stream through the website in real time.

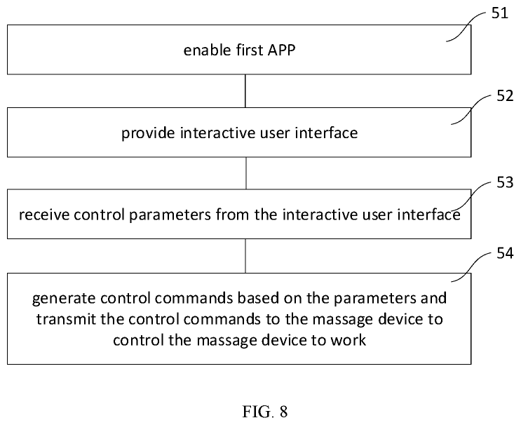

Referring to FIG. 8, a control method for controlling the massage device according to a first embodiment is illustrated. Each block shown in FIG. 8 represents one or more processes, methods, or subroutines, carried out in the method. Furthermore, the illustrated order of blocks is illustrative only and the order of the blocks can be changed. Additional blocks can be added or fewer blocks can be utilized without departing from this disclosure. The control method may begin at block 51.

At block 51, the first APP is enabled at the first terminal device. In at least one embodiment, the first APP is enabled by user input, such as click on an icon of the first APP.

At Block 52, the first APP provides an interactive user interface (for example, the interactive user interface 223a or 223b), which allows a user of the first terminal device to set control parameters.

At block 53, the first APP receives control parameters from the interactive user interface.

At block 54, the first APP generates control commands based on the control parameters set by the user and transmits the control commands to the massage device to control operation of the massage device. In the embodiment, the control commands is transmitted over Bluetooth®.

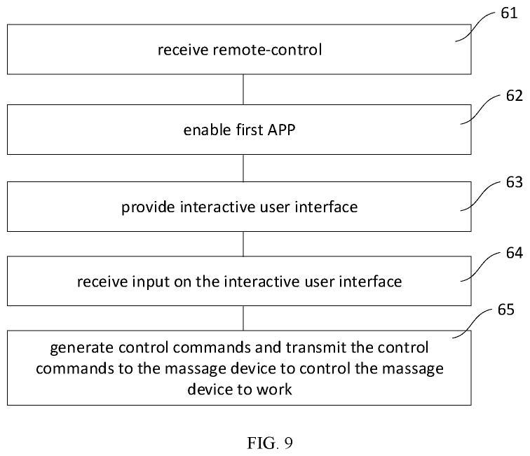

Referring to FIG. 9, a control method for controlling the massage device according to a second embodiment is illustrated. Each block shown in FIG. 9 represents one or more processes, methods, or subroutines, carried out in the method. Furthermore, the illustrated order of blocks is illustrative only and the order of the blocks can be changed. Additional blocks can be added or fewer blocks can be utilized without departing from this disclosure. The control method may begin at block 61.

At block 61, the first terminal device receives remote-control from the second terminal device. In at least one embodiment, the first terminal device and the second terminal device store the second APP 224. The first terminal device can transmit a code to the second terminal device so that the second terminal device can remote-control the first terminal device based on the code. In at least one embodiment, the first terminal device transmits a remote-control request including a remote-control code to the second terminal device. The second terminal device remote-controls the first terminal device based on the remote-control code. Remote-control of the first terminal device may include access and edit data stored in the first terminal device, enable/disable APPs stored in the first terminal device, and etc.

At block 62, the second terminal device enables the first APP stored on the first terminal device.

Blocks 63-65 are same with blocks 52-54, it will not be repeated here.

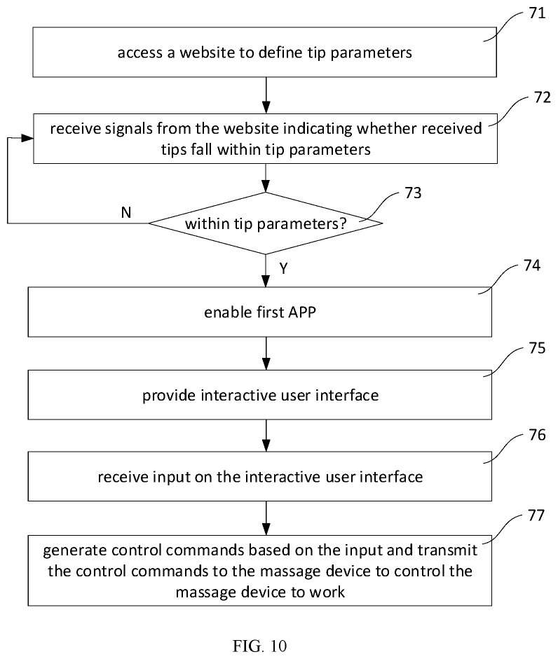

Referring to FIG. 10, a control method for controlling the massage device according to a third embodiment is illustrated. Each block shown in FIG. 10 represents one or more processes, methods, or subroutines, carried out in the method. Furthermore, the illustrated order of blocks is illustrative only and the order of the blocks can be changed. Additional blocks can be added or fewer blocks can be utilized without departing from this disclosure. The control method may begin at block 71.

At block 71, a user of a first terminal device accesses a website to define tip parameters through a web browser to chat with a user of a second terminal device. In at least one embodiment, the chat may be a video chat. The website is configured to allow the first terminal device to define tip parameters, receive tips from the second terminal device, and determine whether the received tips fall within the tip parameters defined by the first terminal device.

At block 72, the first terminal device receives signals from the website indicating whether received tips fall within tip parameters. The tip parameters may include at least one tip value range, for example, 1-10$, 10-15$, 15-20$, and etc. In at least one embodiment, each tip value range corresponds to a work time of the massage device. For example, if received tips falls in the range 1-10$, the second terminal device may control the massage device to work for 10 minutes.

At block 73, the first terminal device determines whether the received tips fall within tip parameters. In at least one embodiment, the website receives tips from the second terminal device, determines whether received tips fall within the tip parameters and then sends a signal to the first terminal device indicating whether received tips fall within the tip parameters. The first terminal device determines whether the received tips fall within tip parameters based on the signal received from the website. If the received tips fall within tip parameters, the process goes to block 74, otherwise, goes back to block 72.

At block 74, the first terminal device enable first APP stored thereon.

At block 75, the first APP provides interactive user interface to the second terminal device through the website.

At block 76, the first terminal device receives input on the interactive user interface (for example, user interface 223a or 223b). The interactive user interface is provided to the website, the website generates a user interface including the interactive user interface to the second terminal device. The second terminal device can input control parameters through the user interface provided by the website. Inputted control parameters can be transmitted to the first terminal device through the website.

At block 77, the first APP generates control commands based on the inputted control parameters and then the control commands are transmitted to the massage device wirelessly so as to control the massage device to work. In at least one embodiment, the control commands are transmitted to the massage device over Bluetooth®.

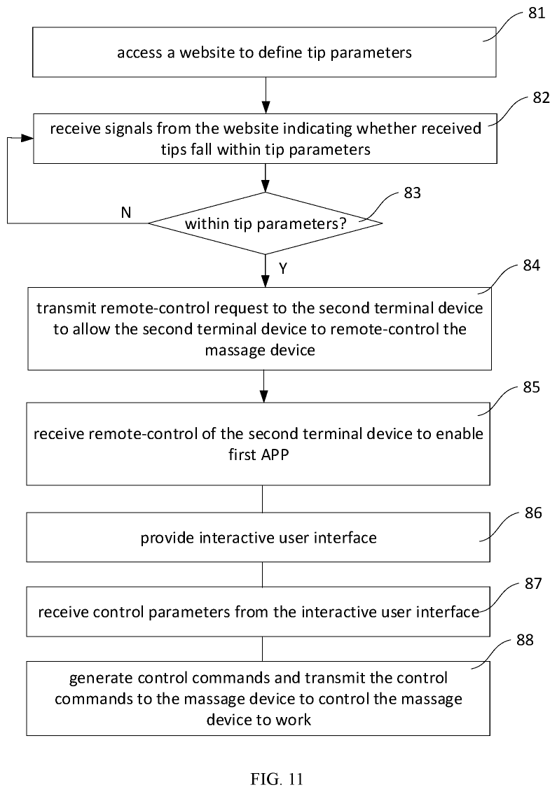

Referring to FIG. 11, a control method for controlling the massage device according to a fourth embodiment is illustrated. Each block shown in FIG. 11 represents one or more processes, methods, or subroutines, carried out in the method. Furthermore, the illustrated order of blocks is illustrative only and the order of the blocks can be changed. Additional blocks can be added or fewer blocks can be utilized without departing from this disclosure. The control method may begin at block 81.

Blocks 81-83 is same with blocks 71-73, it will not be repeated here.

At block 84, the first terminal device transmits a remote-control request to the second terminal device to allow the second terminal device to remote-control the massage device.

At block 85, the first terminal device receives remote-control of the second terminal device to enable first APP.

Blocks 86-88 is same with blocks 63-65, it will not be repeated here.

It should be understood, in other embodiment, the first APP may be stored in the massage device, the second terminal device and the massage device may store the second APP. If received tips fall within the tip parameters, the first terminal device signals the massage device to transmit the remote-control request to the second terminal device, and the second terminal device remote-controls the massage device to control operation of the massage device.

The above description only describes embodiments of the present disclosure, and is not intended to limit the present disclosure, various modifications and changes can be made to the present disclosure. Any modifications, equivalent substitutions, improvements, etc. made within the spirit and scope of the present disclosure are intended to be included within the scope of the present disclosure.

1. A massage device, comprising:
a housing;
a massage unit arranged at the housing, wherein the massage unit comprises a piston, arranged inside the chamber body; and a driving device, configured to drive the piston to reciprocate inside the chamber body so as to generate negative pressure at the suction nozzle;
a massage control unit, configured to control the massage unit to work; and
a wireless communication unit, arranged on the housing and configured to communicate with a terminal device so as to allow the terminal device to control the massage control unit to have the massage unit to work wirelessly.

2. The massage device according to claim 1, wherein the wireless communication unit is configured to receive control commands from the terminal device, the massage control unit is configured to control the massage unit to work according to the control commands.

3. The massage device according to claim 2, wherein the wireless communication unit comprises a Bluetooth® module, the control commands are transmitted through the Bluetooth® module.

4. The massage device according to claim 1, wherein the massage control unit comprises a processor and a storage device, the storage device stores a first APP and a second APP, the first APP is configured to be executed by the processor to provide an interactive user interface and generate the control commands; the second APP is configured to allow the terminal device to remote-control the massage device.

5. The massage device according to claim 4, wherein the control parameters comprise at least one of massage mode, massage speed, massage frequency, massage strength, and massage time.

6. The massage device according to claim 4, wherein the interactive user interface comprises virtual buttons which is capable of being activated to set the control parameters or a virtual drawing panel which allows a user to draw a curve within an axis on the virtual drawing panel to serve as the control parameters.

7. A control system for controlling a massage device, comprising:
a massage device; and
a first terminal device in a wireless communication with the massage device;
wherein the first terminal device is configured to:
enable a first APP;
provide an interactive user interface;
receive control parameters from the interactive user interface;
generate control commands based on the control parameters; and
transmit the control commands to the massage device to control the massage device to work.

8. The control system according to claim 7, wherein the interactive user interface comprises virtual buttons which is capable of being activated to set the control parameters or a virtual drawing panel which allows a user to draw a curve within an axis on the virtual drawing panel to serve as the control parameters.

9. The control system according to claim 7, wherein the control parameters comprise at least one of massage mode, massage speed, massage frequency, massage strength, and massage time.

10. The control system according to claim 7, further comprising a second terminal device, wherein the second terminal device is configured to remote-control the first terminal device to enable the first APP.

11. The control system according to claim 10, further comprising a server configured to provide a website, wherein the website is configured to allow the first terminal device to define tip parameters and the second terminal device to input tips, to receive tips from the second terminal device, to determine whether received tips fall within the tip parameters, and to signal the first terminal device whether received tips fall within the tip parameters;
the first terminal device is further configured to:
access the website through a web browser to input tip parameters;
receive signals from the website indicating whether received tips fall within the tip parameters; and
transmit a remote-control request to the second terminal device to allow the second terminal device to remote-control the first terminal device;
the second terminal device is further configured to:
access the website through a web browser to input tips; and
remote-control the first terminal device in response to the remote-control request.

12. The control system according to claim 10, wherein the first terminal device comprises a first video device configured to provide live stream of the massage device to the website during work time of the massage device, and the second terminal device comprises a second video device configured to receive live stream of the massage device from the website.

13. The control system according to claim 11, wherein the tip parameters comprise at least one tip value range, each tip value range corresponds to a work time of the massage device.

14. The control system according to claim 7, further comprising a second terminal device and a server configured to provide a website, wherein the website is configured to allow a first terminal device to define tip parameters and a second terminal device to input tips, to receive tips from the second terminal device, to determine whether received tips fall within the tip parameters, and to signal the first terminal device whether received tips fall within the tip parameters;
the first terminal device is configured to:
access the website through a web browser to input tip parameters;
receive signals from the website indicating whether received tips fall within the tip parameters; and
enable the first APP if received tips fall within the tip parameters;
the second terminal device is configured to:
access the website through a web browser to input tips.

15. The control system according to claim 14, wherein the first terminal device is further configured to:
transmit the interactive user interface to the website; and
receive control parameters from the website;
the second terminal device is further configured to:
input control parameters on the interactive user interface through the website.

16. The control system according to claim 1, wherein the control commands are transmitted to the massage device over Bluetooth®.

17. A non-transitory storage medium having instructions stored thereon, wherein the instructions comprise a first APP that, when executed by a processor, causes the processor to:
provide an interactive user interface;
receive control parameters from the interactive user interface; and
generate control commands based on the control parameters, wherein the control commands are configured to control a massage device to work according to the control commands, and the non-transitory storage medium is configured to be arranged on a first terminal device or the massage device.

18. The non-transitory storage medium according to claim 17, wherein the interactive user interface comprises virtual buttons which is capable of being activated to set the control parameters or a virtual drawing panel which allows a user to draw a curve within an axis on the virtual drawing panel to serve as the control parameters.

19. The non-transitory storage medium according to claim 17, wherein control parameters comprises at least one of massage mode, massage speed, massage frequency, massage strength, and massage time.

20. The non-transitory storage medium according to claim 17, wherein the instructions when executed by the processor, further causes the processor to:
receive remote-control from a second terminal device;
enable the first APP according to the remote-control.
